(19) United States
(12) Patent Application Publication
(10) Pub. No.: US 2017/0071139 A1
(43) Pub. Date: Mar. 16, 2017

(54) GREENHOUSE WITH SYNCHRONIZING COVER ASSEMBLY AND METHOD FOR INDUCING PLANT PHOTOPERIODISM IN PLANTS

(71) Applicants: Jonah Fence, Ashland, OR (US); Eric Kern, Ashland, OR (US)

(72) Inventors: Jonah Fence, Ashland, OR (US); Eric Kern, Ashland, OR (US)

(21) Appl. No.: 15/259,943

(22) Filed: Sep. 8, 2016

Related U.S. Application Data
(60) Provisional application No. 62/216,810, filed on Sep. 10, 2015.

(51) Int. Cl. A01G 9/22; A01G 9/14

(52) U.S. Cl. CPC A01G 9/227; A01G 9/14

(57) ABSTRACT

Automated shading devices for buildings including one or more shade panels, each with a first end attached to a dispenser, a drive mechanism mechanically connected to the dispenser and configured to cover or uncover a translucent panel with the one or more shade panels, and a control mechanism connected to the drive mechanism and configured to automatically cause the drive mechanism to cover or uncover the translucent panel in accordance with a predetermined schedule. The dispenser is held in tension upon the translucent panel via a telescoping arm. In some examples, the devices include a drive mechanism located proximate to the dispenser. In some further examples, the devices include a drive mechanism located near the base of the telescoping arm.

### CROSS REFERENCE TO RELATED APPLICATIONS

This application claims priority to copending U.S. Provisional Application, Ser. No. 62/216,810, filed on 10 Sep. 2015, which is hereby incorporated by reference for all purposes.

### BACKGROUND

The present disclosure relates generally to systems for controlling ambient lighting conditions in a building. In particular, systems for automatically controlling the raising and lowering of shade panels over windows so as to control the amount of sunlight let through the windows are described.

Shading material has been used throughout history to alter lighting conditions within a building, with respect to sunlight. Such control allows users to set ambient lighting, as well as to provide a measure of temperature control; direct sunlight coming through windows can cause a steady increase in the interior temperatures within a building via radiative heating, beyond normal heat transfer that may occur via conduction from outside air through the building walls.

In the field of agriculture, greenhouses, which consist primarily of windowed walls, are frequently employed in the growing of various plants, as they allow both a controlled environment for the plants, which can shield them from typical weather fluctuations which can greatly impact plant development and timing, as well as allowing sunlight through which is necessary for plant growth. It is known, however, that plants' physiological behavior may be impacted by the duration of sunlight and position of the sun. Changes in the amount of sunlight received can trigger plant behaviors such as blooming, which at least partially explains why flowers and crops occur during only certain seasons of a year. This behavior is known as photoperiodism; manipulating lighting conditions with respect to photoperiodism enables growers to manipulate the timing of plants to flower, produce fruit, etc.

Known systems and methods for providing shade to buildings are not entirely satisfactory for the range of applications in which they are employed. For example, existing shade solutions may be manually driven, requiring human interaction and effort to deploy or retract the shades. This takes away time from a user's schedule, or necessitates a greater expense to have help to manually deploy and retract shading. In some cases, deployment of shades requires interacting with mechanisms such as handcranks, especially where the shades must cover a large area of windows, and manually pulling shades would not be feasible.

Where buildings are used for habitation, such as a workshop or event venue, it may be desirable to shade the interior from direct sunlight to keep the interior from becoming too hot. As the sun tracks across the sky, manually controlled blinds must be periodically readjusted to keep shade in the correct position; otherwise, as the sun moves, portions of the interior may become exposed to full sun. Keeping blinds entirely closed may not be an option, as some ambient light is often desirable, thus necessitating a person to periodically adjust the blinds.

Moreover, where photoperiodism is involved, providing an accurate timing of shade deployment and retraction to obtain the desired plant physiological responses can be difficult; a mistake in timing could result in unwanted physiological responses, or mistimed or delayed responses, ultimately resulting in a potential loss of revenue.

Thus, there exists a need for building shading devices that improve upon and advance the design of known systems and methods for shading buildings. Examples of new and useful automated shading devices relevant to the needs existing in the field are discussed below.

One system currently available from Fullbloom Hydroponics www.fullbloomhydroponics.net) includes shading panels that roll and unroll from roll tubes. The roll tubes are connected to reduction motors, with the assembly in turn being attached to arms on one end of a greenhouse, which themselves attach at a center pivot point. The opposite end of the greenhouse does not have arms, but provides a door for access to the interior of the greenhouse. The arms are designed to work with semi-circular constructed greenhouses.

### SUMMARY

The present disclosure is directed to an automated shading device, comprising one or more shade panels, each with a first end attached to a dispenser, a drive mechanism mechanically connected to the dispenser and configured to cover or uncover a translucent panel with the one or more shade panels, and a control mechanism connected to the drive mechanism and configured to automatically cause the drive mechanism to cover or uncover the translucent panel in accordance with a predetermined schedule.

In one aspect of the disclosed invention, the automated shading device further comprises a telescoping arm that is attached to the dispenser, each of the one or more shade panels further comprises a second end attached to a fixed point, the drive mechanism is configured to cover or uncover the translucent panel by moving the dispenser relative to the fixed point, and the one or more shade panels are either rolled upon or unrolled from the dispenser, respectively.

In another aspect of the disclosed invention, the the telescoping arm further comprises a first end that is attached to the dispenser and a second end distal from the first end that is attached to a pivot point, and the drive mechanism is directly attached to the dispenser at the first end of the telescoping arm.

In another aspect of the disclosed invention, the telescoping arm further comprises a first end that is attached to the dispenser and a second end distal from the first end that is attached to a pivot point, and the drive mechanism is attached to the second end of the telescoping arm, and is configured to mechanically drive the dispenser through the telescoping arm.

In yet another aspect of the disclosed invention the telescoping arm further comprises a tension mechanism so as to cause the dispenser to be held in continuous tension against the translucent panel.

In another aspect of the disclosed invention the tension mechanism further comprises an inner portion, an outer portion that is slideably disposed about the inner portion, and a tension spring that attaches the inner portion to the outer portion such that tension increases as the inner portion slides out of the outer portion.

In another aspect of the disclosed invention the fixed point comprises a point on a greenhouse.

In another aspect of the disclosed invention at least one of the one or more shade panels are opaque to daylight.

In still another aspect of the disclosed invention the predetermined schedule enhances photoperiodism.

In another embodiment of the disclosed invention an automated shading device for light deprivation farming comprises a dispenser with a first dispenser end and a second dispenser end, at least one shade panel attached to the dispenser and configured to at least partially obstruct light, at least one telescoping arm with a first end attached to the first dispenser end, and a second end attached to a pivot point, a drive mechanism mechanically connected to the dispenser and configured to move the dispenser such that the at least one shade panel can be extended from or retracted to the dispenser, and a control mechanism in communication with the drive mechanism and configured to operate the drive mechanism to extend or retract the shade panel from the dispenser on a predetermined schedule.

In another aspect of the disclosed invention the automated shading device further comprises a second telescoping arm with a first end attached to the second dispenser end, and a second end attached to a second pivot point.

In another aspect of the disclosed invention the pivot point attached to the telescoping arm and the second pivot point attached to the second telescoping arm are each attached to a fixed surface.

In yet another aspect of the disclosed invention the telescoping arm and second telescoping arm each further comprise a tension mechanism.

In still another aspect of the disclosed invention each tension mechanism further comprises an inner portion, an outer portion that is slideably disposed about the inner portion, and a tension spring that attaches the inner portion to the outer portion such that tension increases as the inner portion slides out of the outer portion.

In another aspect of the disclosed invention the at least one shade panel rolls upon the dispenser such that rotating the dispenser causes the at least one shade panel to be extended or retracted.

In another aspect of the disclosed invention each tension mechanism is configured to maintain pressure between the dispenser and a substrate upon which the dispenser is disposed.

In still a further aspect of the disclosed invention the predetermined schedule is designed to encourage photoperiodism in plants.

For another embodiment of the disclosed invention, a shading device for controlling lighting conditions in a building comprises a dispenser with a first dispenser end and a second dispenser end, a shade panel with a first end affixed to the dispenser and a second end affixed to the building, two telescoping arms, each with a tension mechanism, a first arm end attached to a pivot point, and a second arm end distal from the first arm end and attached to the first dispenser end and second dispenser end, respectively, a drive mechanism attached to the first dispenser end and configured to move the dispenser so as to cause the shade panel to cover or uncover a building panel disposed therebeneath, and a controller configured to cause the drive mechanism to move the dispenser, wherein the tension mechanisms are configured to maintain the dispenser and shade panel in contact with the building panel as the dispenser moves.

In another aspect of the disclosed invention the drive mechanism comprises a first drive mechanism, and further comprises a second drive mechanism attached to the second dispenser end and configured to move the dispenser in concert with the first drive mechanism.

In still another aspect of the disclosed invention the controller is configured to automatically move the dispenser so as to cover and uncover the building panel in a timing that enhances photoperiodism.

### BRIEF DESCRIPTION OF THE DRAWINGS

FIG. 1 is a perspective view of a first example of an automated shading device for a building.

FIG. 2A is an internal view of the automated shading device for a building shown in FIG. 1 depicting the device as viewed from inside a greenhouse building, with the shade panels retracted.

FIG. 2B is an internal view of the automated shading device for a building shown in FIG. 1 depicting the device as viewed from inside a greenhouse building, with the shade panels deployed.

FIG. 3 is a perspective view of the automated shading device for a building shown in FIG. 1 depicting the drive assembly positioning with respect to the dispenser and telescoping arm.

FIG. 4 is a perspective close-up view of the dispenser and shade panel in a retracted position of the automated shading device for a building shown in FIG. 1.

FIG. 5A is an exploded view of one possible configuration of the internal mechanism of one possible embodiment of the telescoping arm for the automated shading device shown in FIG. 1.

FIG. 5B is an exploded view of a second possible configuration of the internal mechanism of one possible embodiment of the telescoping arm for the automated shading device shown in FIG. 1.

FIG. 6 is a perspective view of a second example of an automated shading device for a building.

FIG. 7 is a flow chart of an example method for providing automated shading that enhances plant photoperiodism, useful for implementation with the automated shading devices shown in FIGS. 1 and 6.

### DETAILED DESCRIPTION

The disclosed automated shading devices will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various automated shading devices are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

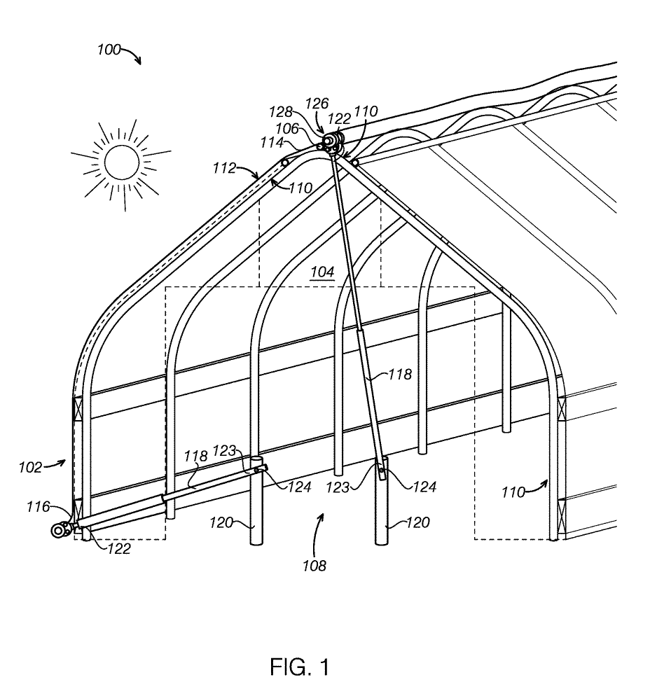

With reference to FIGS. 1-5B, a first example of an automated shading device, device 100, will now be described. Device 100 functions to provide a system that can adjust ambient lighting conditions inside a building by automatically controlling the raising and lowering of shade panels over windows. As will be discussed below, in the preferred embodiment of device 100 shade panels are stored on a dispenser which is kept in tension upon the building windows, allowing device 100 to conform to the surface profile of the building while deploying or retracting the shade panels. By integrating a controller with device 100, lighting conditions can be tuned to match specific requirements, regardless of season. Device 100 is ideal for use with greenhouses and other similar buildings that are typically used for nursery operations, where various physiological responses can be triggered in many plant species by adjusting lighting conditions. The reader will appreciate from the figures and description below that device 100 addresses shortcomings of conventional systems and shading devices for buildings.

For example, device 100 provides for automated deployment of shade panels, and can support buildings such as greenhouses where the shade panels are of considerable size, and otherwise unwieldly to handle absent some sort of mechanical assistance. Further, by supplying a control or timing mechanism, device 100 can be programmed with a deployment schedule that enhances or encourages photoperiodic behavior in plants, and does so on an automatic basis, thereby enabling consistent desired plant behavior, potentially regardless of the season. Where the building is a workshop or event venue, as opposed to a greenhouse, the control mechanism can drive shades automatically slowly over time, to track the position of the sun and keep the interior relatively shaded and temperate, while still allowing for ambient light.

Automated shading device 100 for controlling lighting conditions within a building 102 includes one or more shade panels 112, each with a first end 116 attached to a dispenser 126. A drive mechanism 128 is mechanically connected to dispenser 126 and configured to cover or uncover a translucent panel 110 with the one or more shade panels 112. A control mechanism can be connected to drive mechanism 128, and configured to automatically cause drive mechanism 128 to cover or uncover the translucent panel 110 in accordance with a predetermined schedule.

As can be seen in FIG. 1, building 102, which in the depicted embodiment is a greenhouse, includes two building ends 104 and an apex 106, combining to enclose an interior space 108 that is the intended target for controlled shading provided by device 100. A greenhouse comprises an ideal building 102 upon which to implement device 100, as device 100 allows automatic control of light and shade for plants that would typically be placed inside a greenhouse. However, a greenhouse is only one possible use for device 100; it should be appreciated that building 102 can be any building where control of shade and light is desirable. Examples of such buildings may include sun patios, meeting and event spaces, solariums, workshops, barns, mobile buildings, habitats, or any other building now known or later developed where automatic control of shading is desirable. Building 102 need not be constructed in any particular fashion; conventional building methods can be utilized.

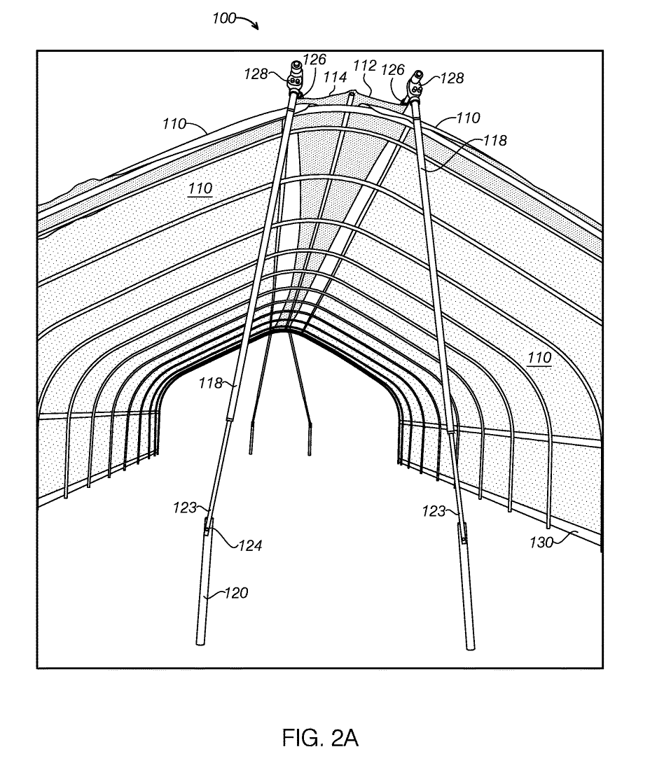

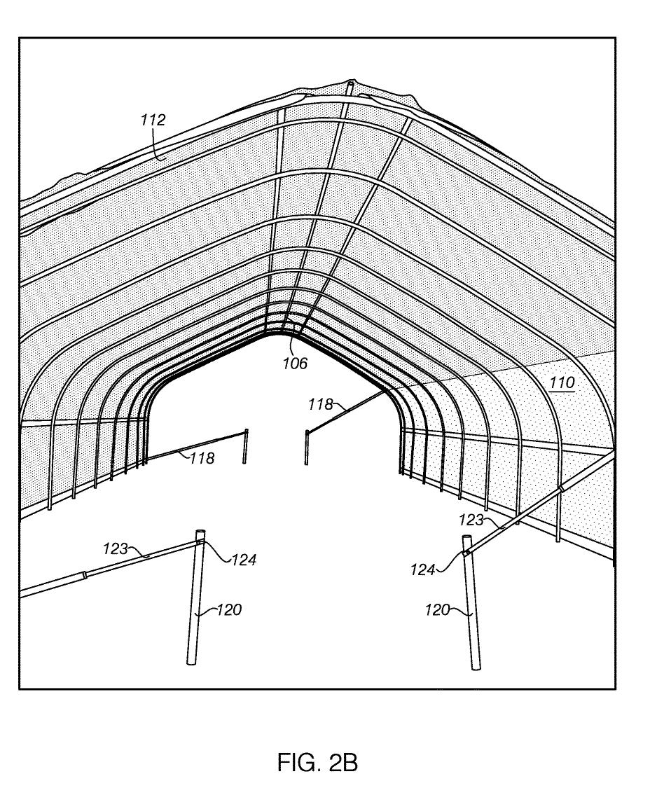

Again, as seen in FIGS. 1 and 2A, apex 106 to building base 130 presents a continuous but curved surface, with a seamless transition from a sloped roof surface to an approximately vertical wall. Some such example buildings 102 may have a clearly defined roof and walls, and device 100 may be deployed to only shade windows located on a particular surface, e.g. just roof skylights, or just side windows. Furthermore, while building end 104 is only depicted in dashed lines in FIG. 1, building end 104 may be solid, partially solid, or in some examples may be missing entirely, similar to the depiction of FIGS. 2A and 2B. While device 100 is not depicted as covering building end 104 with shade panels 112 in FIG. 1, it should also be understood that device 100 could be deployed to cover a building end 104 in other deployments.

Building 102 is at least partially sheathed with one or more translucent panels 110, that allow for the transmission of light when uncovered. Continuing with the preferred embodiment of building 102 as a greenhouse, translucent panels 110 are preferably flexible, yet sufficiently rigid so as to protect the interior space 108 of greenhouse 102 from winds, sunlight, insects, and falling objects. Translucent panels 110 may be constructed from a thin plastic that is transparent or translucent, yet still having the capacity to retain a significant portion of the heat generated by the sun or other means in the interior space 108 of building 102. Alternatively or additionally, translucent panels 110 can be constructed from any suitable material that is light transmissive, such as glass, plastics such as acrylic or polycarbonate, quartz, or any other similar material now known or later developed. Furthermore, translucent panels 110 in some embodiments may be structural to building 102.

Shade panels 112 are constructed from a light attenuating material that is capable of being stored upon dispenser 126. Depending upon the particular application of device 100, shade panels 112 may be either opaque so as to completely block light, or partially translucent, so as to allow some light through to translucent panels 110, albeit at a significantly attenuated level compared to the light level that would otherwise pass through translucent panels 110 absent the presence of shade panels 112. In the preferred embodiment, shade panels 112 have a first end 116 that is attached to dispenser 126, and a second end 114 that is attached to a fixed point upon building 102.

Suitable materials for shade panels 112 can include any flexible material that is opaque or light attenuating, such as sheeting made from plastic, fabric, metal, or any other suitable material that can be configured to be stored by dispenser 126 and withstand the stresses of deployment and retraction by device 100. The sheeting could be solid and continuous, similar to a blackout curtain, or could include perforations, such as a screen material or loosely woven fabric. In other applications the material could be continuous yet translucent, such as a neutrally tinted sheet that allows light to be transmitted, but at an attenuated level, similar to a sunglass lens. In still other applications, the material could be specifically tinted to allow some light wavelengths through while blocking others, similar to a color filter, where shading from only certain parts of the spectrum is necessary.

FIGS. 2A and 2B depict shade panels 112 in various states of deployment upon building 102. As can be seen in the figures, building 102 is an example greenhouse with two sides equipped with translucent panels 110, and two devices 100, one corresponding to each side. In FIG. 2A, each device 100 is shown with shade panels 112 in a retracted position, with dispensers 126 located proximate to apex 106. In this configuration, translucent panels 110 are exposed and thereby can allow sunlight (or any other proximate light source) to pass through to interior space 108.

Conversely, in FIG. 2B, shade panels 112 are shown in a deployed position. Specifically, device 100 on the left hand side is positioned proximate to building base 130, with corresponding shade panels 112 completely covering translucent panels 110 so as to prevent exterior light from entering into interior space 108. Device 100 on the right hand side is deployed approximately at the mid-point of the wall of building 102, allowing ambient light to pass through those portions of translucent panels 110 that are located between the position of dispenser 126 and building base 130. Such a position would offer complete shade where the sun is located to the left of apex 106, and the position of shade panels 112 could be adjusted by each device 100 respectively to track the position of the sun as it moves across the sky. This will be discussed in greater detail herein.

Shade panels 112 are stored on dispenser 126. In the embodiment of FIG. 1, a single dispenser 126 is configured to shade a single side of building 102. As noted above, in the disclosed example shade panels 112 are attached to a fixed point upon building 102 via second end 114, while first end 116 is affixed to dispenser 126. Where shade panels 112 are flexible, dispenser 126 can retract or deploy shade panels 112 by rolling or rolling, respectively, shade panels 112 about its axis. One or more shade panels 112 can be deployed; depending upon the configuration of building 102, dispenser 126 could be equipped with a single shade panel 112 that is sized to accommodate the entire width of all translucent panels 110 on a given side of building 102. Alternatively, dispenser 126 could be equipped with multiple shade panels 112 that are placed to dispose upon multiple corresponding translucent panels 110. First end 116 and second end 114 of shade panels 112 can be affixed to dispenser 126 and building 102, respectively, by any means suitable to ensure that shade panels 112 will remain affixed throughout the lifetime and normal use cycles of device 100. Such means could include mechanical fastening means such as nails, screws, flanges, slots that receive a rigged or doubled edge of shade panels 112, or other similar means, or adhesives such as glue or cement, to name a few examples.

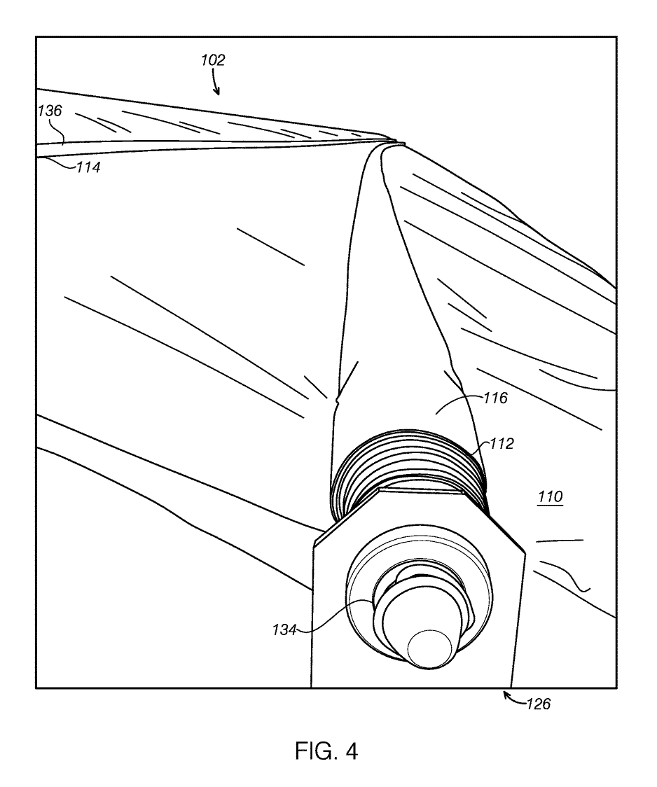

In the example shown in FIG. 4, one example embodiment of dispenser 126 is shown in greater detail. First end 116 of shade panel 112 is shown clearly rolled upon dispenser 126, in a semi-deployed configuration. First end 116 is affixed to dispenser 126 by similar means as second end 114 is affixed to building 102, as described above. However, first end 116 and second end 114 need not be affixed to their respective locations by identical means. Dispenser 126 thus rotates about its longitudinal axis to deploy or retract shade panel 112, storing by rolling up shade panel 112 about dispenser 126, and traveling toward apex 106, and deploying by unrolling shade panel 112 as it travels away from apex 106 towards building base 130. To the right side of the figure translucent panel 110 is visible, with shade panel 112 disposed atop translucent panel 110 on the left side of the figure. Second end 114 is shown attached near the apex 106 of building 102. Visible in the foreground is second dispenser end 134, one point where dispenser 126 is mechanically linked to telescoping arm 118, which will be discussed in greater detail herein.

As depicted in FIG. 4 second dispenser end 134 is essentially an axial bearing, about which dispenser 126 rotates. Second dispenser end 134 can optionally be equipped with a spring or other tension device that is mechanically linked to both telescoping arm 118 and the rotating axis of dispenser 126, thereby imparting a tension against dispenser 126 as it unrolls and travels down the side of building 130, and assisting dispenser 126 as it travels back up towards apex 106, storing shade panel 112.

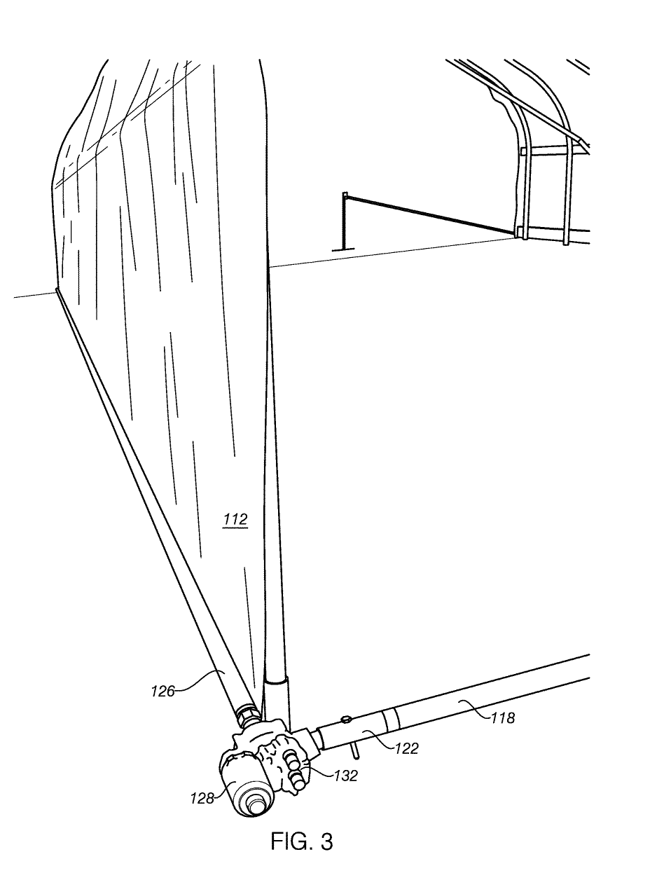

In the depicted embodiment dispenser 126 is essentially a tubular structure that rotates about its longitudinal axis, and may be essentially a pipe upon which is affixed first end 116 of shade panel 112. Dispenser 126 may be constructed from any material suitably rigid and durable to withstand repeated cycles of device 100, such as metal like iron, steel, copper, bronze, or similar metals, plastics such as ABS or PVC, wood, ceramic, a combination of such materials, or any other suitable material now known or later developed. However, while depicted as a tubular structure in FIG. 3, this depiction is not intended to limit possible embodiments of dispenser 126. Dispenser 126 can be configured in any fashion suitable to the nature of shade panel 112. For example, shade panel 112 could be implemented using a series of stacking or nesting panels, in which case dispenser 126 could more suitably be configured as a non-rotating rectangular box. For a second example, shade panel 112 could be configured to fold repeatedly in an accordion-like fashion. In such an implementation dispenser 126 would likely need only be a non-rotating bar that secured the end of shade panel 112 and ensured it would be pulled and unfolded for deployment. Again, these two examples are not intended to be limiting, but merely illustrative of possible different configurations for dispenser 126.

FIG. 4 also depicts an apex vent 136, with which building 102 may be optionally equipped. Apex vent 136 may be useful on buildings such as greenhouses, event spaces, or workshops, for example, where some degree of air circulation is desirable. When building 102 is so configured, second end 114 of shade panel 112 is preferably affixed just below apex vent 136, so as to prevent blocking of the vent by shade panel 112 as it deploys. Alternatively, shade panel 112 could be fashioned to include apex vent 136 as part of its structure, where apex vent 136 becomes uncovered and functional as shade panel 112 unfurls and is deployed. In such a configuration, translucent panels 110 and/or apex 106 may be configured with ventilation openings near apex 106 which are open while shade panel 112 is stored, and remain available for air flow via apex vent 136 as shade panel 112 deploys. While apex vent 136 is depicted as a ridge line just below apex 106, this depiction is not intended to be limiting, and apex vent 136 could be configured in any suitable shape to achieve desired ventilation.

Referring now to FIG. 3, drive mechanism 128 located upon telescoping arm 118 is depicted. Drive mechanism 128 is mechanically connected to dispenser 126 at first dispenser end 132, which in turn is attached to telescoping arm 118 at first arm end 122. Drive mechanism 128 is thus configured to mechanically drive dispenser 126 to either deploy or retract shade panels 112. As dispenser 126 is configured to rotate to deploy or retract shade panels 112, drive mechanism accordingly imparts a rotational motion upon dispenser 126. As dispenser 126 rotates from the imparted motion, the entire assembly of dispenser 126, drive mechanism 128 and telescoping arm 118 moves along the surface of building 102, either deploying upon or retracting from translucent panels 110 shade panels 112. As depicted in FIG. 3, drive mechanism 128 is directly connected to dispenser 126.

In the depicted embodiments in FIGS. 1 to 5B, each device 100 possesses two telescoping arms 118, one corresponding to each building end 104. Dispenser 126 is disposed between each telescoping arm 118, with a first dispenser end 132 interfacing with the telescoping arm 118 that includes drive mechanism 128, and a second dispenser end 134 interfacing with the telescoping arm 118 that is positioned distal from the telescoping arm 118 that includes drive mechanism 128. Notably, each device 100 only includes a single drive mechanism 128, which is affixed to first dispenser end 132, while leaving second dispenser end 134 undriven, save perhaps a tension spring as mentioned herein. This configuration is not intending to be limiting, and the configuration of device 100 may vary depending upon the requirements of building 102 without departing from the disclosed invention. For example, some implementations of device 100 may include a drive mechanism 128 on each end of dispenser 126, which would be synchronized by some mechanism, such as a controller. Such an arrangement could be advantageous for deployments where dispenser 126 is particularly lengthy, and it would thus not be feasible to use a tension spring alone upon second dispenser end 134. Including a drive mechanism 128 on each end of dispenser 126 would allow the position of each end of dispenser 126, and the corresponding portion of translucent panels 110 shaded by shade panels 112, to be relatively consistent across the face of building 102, to account for possible sag in long runs of dispenser 126.

Alternatively, drive mechanism 128 could be configured to move dispenser 126 along the surface of building 102 by using a driving mechanism that is separate from dispenser 126, such as a drive wheel or wheels. In such a configuration, dispenser 126 could deploy shade panels 112 solely by tension imparted between dispenser 126 and second end 114, with shade panels 112 transmitting the tension, and retract shade panels 112 by tension supplied by the aforementioned spring located on second dispenser end 134. This configuration is provided as an example of a possible drive method, and is in no way intended to limit the possible configuration of drive mechanism 128 with respect to dispenser 126.

Drive mechanism 128, in the example depicted in FIG. 3, is preferably implemented using a motor, potentially connecting through a gear reduction or other similar transmission to ensure that dispenser 126 is driven with the correct rotational speed and with sufficient torque. The motor of the example drive mechanism 128 can be AC or DC powered, of a brushed or brushless configuration, as suited to the available power supply and controlling electronics. Whether a gear reduction is needed depends upon the specifications of the drive motor. A motor that produces a greater rotational speed at comparatively lower torque would benefit from a gear reduction that converts rotational speed to additional torque. Furthermore, the configuration of the gear reduction in conjunction with the motor will determine the deployment speed of shade panels 112. It should be understood that the foregoing is only one possible implementation of drive mechanism 128, and that the configuration of drive mechanism 128 can vary depending upon the nature of dispenser 126 and the requirements of building 102.

Telescoping arm 118 is attached between a first arm end 122, which is connected to drive mechanism 128 and first dispenser end 132, and second arm end 123, which in turn is attached to arm base 120. The connection between second arm end 123 and arm base 120 forms pivot point 124, about which telescoping arm 118 pivots as drive mechanism 128 causes dispenser 126 to deploy or retract shade panels 112. Arm base 120 is secured to a fixed point, such as the ground proximate to building 102, as depicted in the figures, for example. Alternatively, arm base 120 can be fixed to any point that enables telescoping arm 118 to correctly pivot as dispenser 126 deploys or retracts shade panels 112. Such a point could be located upon building 102, or any sufficient adjacent structures.

In the preferred embodiment, for each device 100 dispenser 126 is secured at either end to a telescoping arm 118. Each telescoping arm 118, with its own pivot point 124 and separate arm base 120, can be anchored at various points near building end 104. This configuration allows at least the center of each building end 104 to be kept clear, and as such can enable a door to be installed on either building end 104. Furthermore, the use of a telescoping arm 118 to support each end of dispenser 126 provides a more robust support for dispenser 126, and enhances resistance to high wind conditions. Use of telescoping arms 118 further enables device 100 to be deployed on buildings 102 with a variety of different roof profiles, as dispenser 126 can closely travel the roof profile.

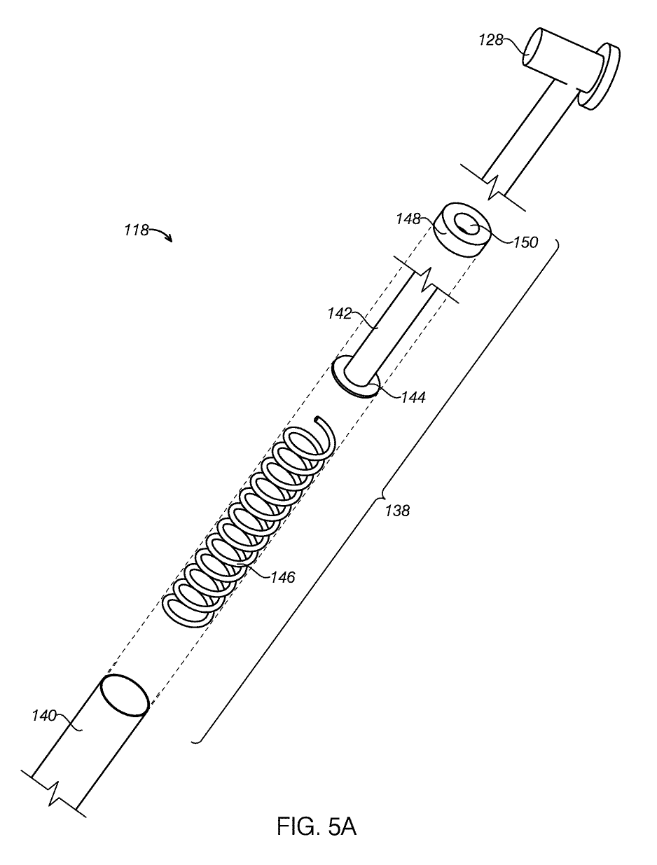

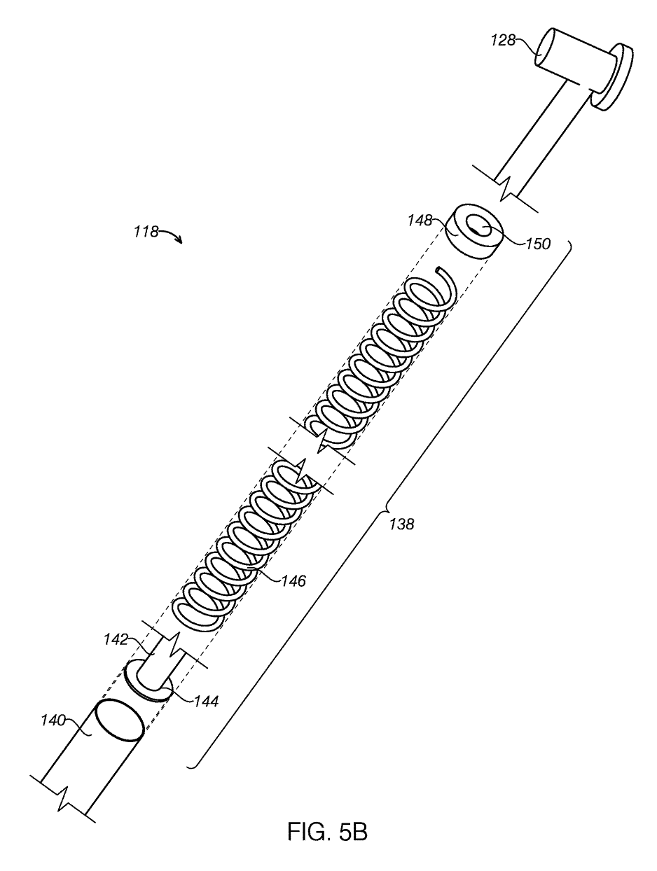

Turning to FIG. 5A, the internal structure of one possible implementation of telescoping arm 118 is depicted. Telescoping arm 118 includes a tension mechanism 138, the possible components of which are depicted in FIGS. 5A and 5B, which further comprises an inner portion 142, an outer portion 140 that is slideably disposed about inner portion 142, and a tension spring 146 that attaches inner portion 142 to outer portion 140 such that tension increases as inner portion 142 slides out of outer portion 140. The end of outer portion 140 where inner portion 142 inserts is fitted with an end cap 148, which in turn has an aperture 150 through which inner portion 142 slides, thereby protecting the interior of outer portion 140 and tension spring 146 from being exposed to possible contaminants.

Tension spring 146 is secured at one end to a flange 144, which is attached to the end of inner portion 142 that is inserted into outer portion 140. The opposing end of tension spring 146 is secured to the interior of outer portion 140 distal to the opening of outer portion 140 that receives inner portion 142. Tension spring 146 is sized so that as inner portion 142 slides out of outer portion 140, thus causing telescoping arm 118 to increase in overall length, tension spring 146 is pulled and supplies a resistive force to urge inner portion 142 to slide back into outer portion 140. Tension spring 146, in its normal resting configuration, would be at a length that keeps telescoping arm 118 at its shortest length. Thus, when telescoping arm 118 is fully retracted, tension spring 146 is either fully relaxed, or still in a state of semi-tension. Tension spring 146 is constructed of any material suitable for constructing a spring, such as appropriately treated metal, typically in a coiled configuration as is well known in the art, or plastic, composites, or any combination of suitable materials now known or later developed.

FIG. 5B shows an alternative possible arrangement of the internal components of telescoping arm 118. Rather than having tension spring 146 be stretched, tension spring 146 attaches between flange 144 and end cap 148, and is thus compressed as inner portion 142 slides out of outer portion 140, thereby lengthening telescoping arm 118. The compression of tension spring 146 thereby supplies the resistive force urging inner portion 142 to slide into outer portion 140. Similar to the configuration in FIG. 5A, the resting length of tension spring 146 is configured to support telescoping arm 118 in a fully retracted position, possibly with some compression of tension spring 146 still present.

The configuration of telescoping arm 118 depicted in FIGS. 5A and 5B are only two possible example configurations, and should not be understood as limiting. Telescoping arm 118 could have a number of different internal configurations so long as telescoping arm 118 offered increasing resistance against lengthening, and had a tendency to retract in length. Other possible mechanisms could include gas shocks or struts, magnetic retractors, hydraulics, or any other similarly functional mechanism.

Telescoping arms 118 and their constituent components can be constructed from any suitable materials capable of withstanding the stresses imposed by device 100 as shade panels 112 are deployed or retracted. Such materials may include metal, plastic, wood, composites, or any other suitable materials now known or later developed.

Finally, it should be noted that while FIGS. 1 through 5B depicted devices 100 as disposing shade panels 112 on the exterior of building 102, upon the exterior facing side of translucent panels 110 and with telescoping arm 118 applying tension to keep dispenser 126 against the surface of building 102, this is only one possible arrangement. Depending upon the profile of building 102, device 100 could be configured to place shade panels 112 on the interior of building 102, within interior space 108, against the inside surface of translucent panels 110. In such a configuration, telescoping arms 118 would be configured to supply an outward pressure against translucent panels 110, and would provide increasing resistance against telescoping arms 118 getting shorter, as inner portion 142 slid into outer portion 140. By way of example only, and not intending to be limiting, changing the configuration of tension spring 146 to generally be in compression, with respect to a telescoping arm 118 configured per FIG. 5A, or to generally be in tension, with respect to a telescoping arm 118 configured per FIG. 5B, would achieve a telescoping arm 118 that is fully extended at rest, and would be suitable for supplying an outward pressure where device 100 is utilized on interior surfaces.

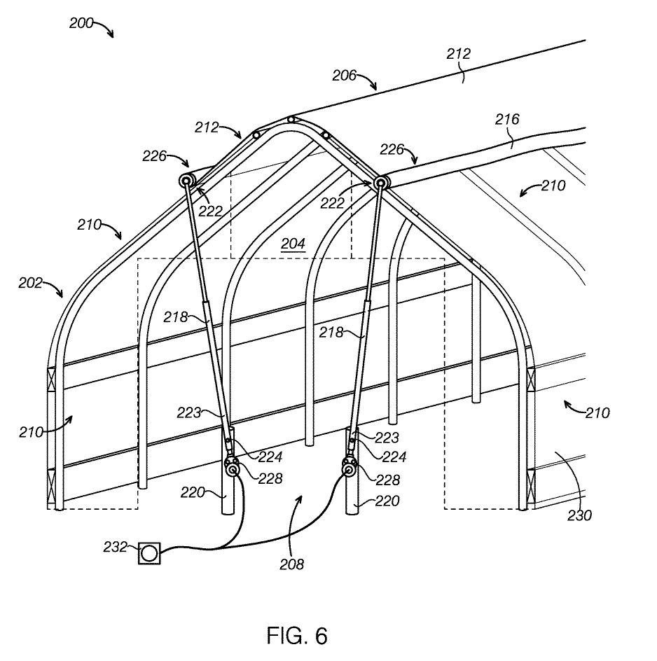

Turning attention to FIG. 6, a second example of an automated shading device for a building, device 200, will now be described. Device 200 includes many similar or identical features to device 100. Thus, for the sake of brevity, each feature of device 200 will not be redundantly explained. Rather, key distinctions between device 200 and device 100 will be described in detail and the reader should reference the discussion above for features substantially similar between the two devices.

As can be seen in FIG. 6, device 200 includes a building 202 which includes a plurality of building ends 204, and is topped at an apex 206. Shade panels 212 that provide light blocking or attenuation are disposed upon translucent panels 210. Shade panels 212 are stored or retracted via a dispenser 226, onto which is attached a first end 216 of shade panel 212. Each dispenser 226 is attached between two telescoping arms 218 at first arm ends 222, which in turn are attached to arm bases 220 at pivot point 224. Pivot points 224 allow telescoping arms 218 to travel between apex 206 and building base 230 for deployment of shade panels 212.

As opposed to the previous embodiment, drive mechanisms 228 are attached proximate to pivot points 224, providing drive motion by acting upon telescoping arms 218, as opposed to directly turning dispensers 226. This position of drive mechanism 228 is suited to device configurations where dispenser 226 includes a tension spring at each first arm end 222 where dispenser 226 is held to telescoping arm 218. This arrangement can alleviate some measure of stress from telescoping arm 218, if so needed or desired. As with the previous embodiment, drive mechanisms 228 may be located on only one telescoping arm 218 of a device 200, or may be located on each telescoping arm 218 corresponding to each building end 204.

Also depicted in FIG. 6 is controller mechanism 232, which is in electrical communication with drive mechanisms 228. Controller mechanism 232 is configured to enable device 200 to automatically drive shade panels 212 to deploy or retract on a programmed schedule, per a user's requirements. The programmed schedule can be arbitrary, set to cause retraction or deployment at various times of day, or can be programmed to synchronize with the passage of the sun in the sky so as to provide control over lighting conditions inside of building 202. A single controller mechanism 232 may be configured to coordinate the movements of multiple devices 200. For example, in FIG. 6 a device 200 is provided for each side of building 202. Controller mechanism 232 can be placed in electrical communication with all drive mechanisms 228 associated with each device 200, and can thus coordinate the positions of each shade panel 212 on each side of building 202.

Controller mechanism 232 may be deployed using any control technology now known or later developed, such as a general purpose computer running special software, a dedicated control unit, or an embedded control unit that is part of drive mechanism 228. Thus, controller mechanism 232 may be implemented using commercially available processors, such as those available from Intel, Atmel, or ARM-based processors. Further still, controller mechanism 232 could be implemented using application-specific developed microelectronics, or may be implemented using mechanical timing means. Controller mechanism 232 may be powered by electricity, via batteries or household current, or could be powered by other means such as mechanically stored energy.

While controller mechanism 232 is disclosed in connection with device 200, it should be recognized that controller mechanism 232 is equally useful with device 100.

Finally, it can be observed from FIG. 6 that shade panels 212 lack a second end, instead having a single first end 216, each attached to one dispenser 226, thereby forming a single shade panel 212 or shade panels 212 that span between each device 200, as opposed to device 100, where each shade panel 112 is separate and anchored via second end 114 to a fixed point on building 102. In this configuration, shade panels 212 float atop building 202 across apex 206, and need not be connected, instead relying upon counter tension from each device 200.

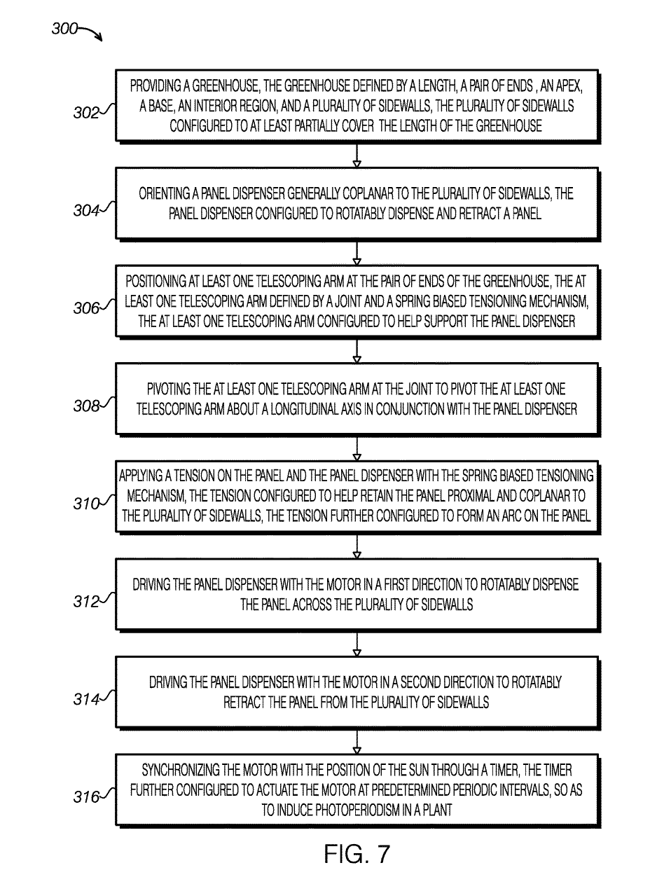

Turning attention to FIG. 7, a method 300 of using an automated shading device in connection with a greenhouse to induce photoperiodism will now be described. Method 300 includes a first step 302 of providing a greenhouse with two ends, an apex, a base, and translucent sidewalls that cover at least a part of the length of the greenhouse. In step 304, a dispenser is suppled that is configured to rotatably dispense and retract shade panels that are disposed upon the translucent sidewalls so as to prevent or attenuate light passing though the translucent sidewalls. Telescoping arms are positioned at each end of the greenhouse in step 306, with each telescoping arm including a pivot point and a tensioning spring to keep the dispenser in close contact with the translucent sidewalls. This pivot point results in the telescoping arm rotating about a longitudinal axis parallel to the longitudinal axis of the dispenser in step 308.

Tension is applied to the shade panel with the tensioning spring configured to help retain the dispenser in contact with the sidewall, in step 310, to enable it to conform to the contours of the greenhouse's sidewalls. The tension further can cause the dispenser to form an arc shape, thereby assisting in the shade panels to shed rain water. In step 312 the dispensers are driven with a motorized drive mechanism to cause the panels to be dispensed across the greenhouse sidewalls. Conversely, step 314 has the dispensers being driven to retract the panels from the sidewalls.

Last, in step 316 the drive mechanisms are synchronized with the position of the sun via a timing mechanism. The timing mechanism is programmed to induce photoperiodism in plants placed within the greenhouse. As a result, the timing program may vary depending upon the particular plants placed within the greenhouse, and the particular needs of the plant grower.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. An automated shading device, comprising:
one or more shade panels, each with a first end attached to a dispenser;
a drive mechanism mechanically connected to the dispenser and configured to cover or uncover a translucent panel with the one or more shade panels; and
a control mechanism connected to the drive mechanism and configured to automatically cause the drive mechanism to cover or uncover the translucent panel in accordance with a predetermined schedule.

2. The automated shading device of claim 1, further comprising a telescoping arm that is attached to the dispenser, and wherein:
each of the one or more shade panels further comprises a second end attached to a fixed point,
the drive mechanism is configured to cover or uncover the translucent panel by moving the dispenser relative to the fixed point, and
the one or more shade panels are either rolled upon or unrolled from the dispenser, respectively.

3. The automated shading device of claim 2, wherein:
the telescoping arm further comprises a first arm end that is attached to the dispenser and a second arm end distal from the first arm end that is attached to a pivot point; and
the drive mechanism is directly attached to the dispenser at the first arm end of the telescoping arm.

4. The automated shading device of claim 2, wherein:
the telescoping arm further comprises a first arm end that is attached to the dispenser and a second arm end distal from the first arm end that is attached to a pivot point; and
the drive mechanism is attached to the second arm end of the telescoping arm, and is configured to mechanically drive the dispenser through the telescoping arm.

5. The automated shading device of claim 2, wherein the telescoping arm further comprises a tension mechanism so as to cause the dispenser to be held in continuous tension against the translucent panel.

6. The automated shading device of claim 5, wherein the tension mechanism further comprises an inner portion, an outer portion that is slideably disposed about the inner portion, and a tension spring that attaches the inner portion to the outer portion such that tension increases as the inner portion slides out of the outer portion.

7. The automated shading device of claim 2, wherein the fixed point comprises a point on a greenhouse.

8. The automated shading device of claim 1, wherein at least one of the one or more shade panels are opaque to daylight.

9. The automated shading device of claim 1, wherein the predetermined schedule enhances photoperiodism.

10. An automated shading device for light deprivation farming, comprising:
a dispenser with a first dispenser end and a second dispenser end;
at least one shade panel attached to the dispenser and configured to at least partially obstruct light;
at least one telescoping arm with a first end attached to the first dispenser end, and a second end attached to a pivot point;
a drive mechanism mechanically connected to the dispenser and configured to move the dispenser such that the at least one shade panel can be extended from or retracted to the dispenser; and
a control mechanism in communication with the drive mechanism and configured to operate the drive mechanism to extend or retract the shade panel from the dispenser on a predetermined schedule.

11. The automated shading device of claim 10, further comprising a second telescoping arm with a first end attached to the second dispenser end, and a second end attached to a second pivot point.

12. The automated shading device of claim 11, wherein the pivot point attached to the telescoping arm and the second pivot point attached to the second telescoping arm are each attached to a fixed surface.

13. The automated shading device of claim 12, wherein the telescoping arm and second telescoping arm each further comprise a tension mechanism.

14. The automated shading device of claim 13, wherein each tension mechanism further comprises an inner portion, an outer portion that is slideably disposed about the inner portion, and a tension spring that attaches the inner portion to the outer portion such that tension increases as the inner portion slides out of the outer portion.

15. The automated shading device of claim 14, wherein the at least one shade panel rolls upon the dispenser such that rotating the dispenser causes the at least one shade panel to be extended or retracted.

16. The automated shading device of claim 15, wherein each tension mechanism is configured to maintain pressure between the dispenser and a substrate upon which the dispenser is disposed.

17. The automated shading device of claim 16, wherein the predetermined schedule is designed to encourage photoperiodism in plants.

18. A shading device for controlling lighting conditions in a building, comprising:
a dispenser with a first dispenser end and a second dispenser end;
a shade panel with a first end affixed to the dispenser and a second end affixed to the building;
two telescoping arms, each with a tension mechanism, a first arm end attached to a pivot point, and a second arm end distal from the first arm end and attached to the first dispenser end and second dispenser end, respectively;
a drive mechanism attached to the first dispenser end and configured to move the dispenser so as to cause the shade panel to cover or uncover a building panel disposed therebeneath; and
a controller configured to cause the drive mechanism to move the dispenser,
wherein the tension mechanisms are configured to maintain the dispenser and shade panel in contact with the building panel as the dispenser moves.

19. The shading device of claim 18, wherein the drive mechanism comprises a first drive mechanism, and further comprising a second drive mechanism attached to the second dispenser end and configured to move the dispenser in concert with the first drive mechanism.

20. The shading device of claim 18, wherein the controller is configured to automatically move the dispenser so as to cover and uncover the building panel in a timing that enhances photoperiodism.
